(19) United States
(12) Patent Application Publication
(10) Pub. No.: US 2002/0192546 A1
(43) Pub. Date: Dec. 19, 2002

(54) Multi-salt electrolyte for electrochemical applications

(76) Inventors: Zhenhua Mao, Ponca City, OK (US); Ji-Guang Zhang, Marietta, GA (US); Aishui Yu, Atlanta, GA (US); Richard C. Breitkopf, Atlanta, GA (US)

Correspondence Address: Edwina Thomas Washington, Excellatron Solid State, LLC, Suite J, 1640 Roswell Street, Smyrna, GA, 30080, US

(21) Appl. No.: 09/876,472

(22) Filed: Jun. 7, 2001

(51) Int. Cl. H01M 10/40

(52) U.S. Cl. 429/188; 429/339; 429/337; 429/338; 429/342

(57) ABSTRACT

Systems and methods for providing electrolytes having a multi-salt mixture used in electrochemical systems such as lithium ion batteries. The battery system generally includes a cathode, anode and electrolyte cells. The cells prepared with the multi-salt electrolyte, for instance, a mixed lithium/sodium mixed salt electrolyte, exhibit nearly the same capacity as those using pure lithium salt electrolyte. These cells exhibit improved cyclability, smaller internal resistance and better rate capability than those using pure lithium electrolyte. The multi-salt electrolyte is electrochemically stable within a voltage range of about 4.8 to 2.5 V. The mixed Li/Na salt electrolytes provide a cost alternative to a pure lithium salt and enhance the electrochemical properties of lithium ion batteries.

### FIELD OF INVENTION

This invention relates to electrolytes, and more particularly, to the preparation and application of a multi-salt electrolyte for electrochemical applications.

### BACKGROUND OF THE INVENTION

Lithium-ion batteries are known to have a high energy density, long cycle life, and low self-discharge compared to other rechargeable batteries and are now widely used for portable electronic devices such as cellular phones and laptop computers. However, the commercial use of electric and hybrid vehicle technologies has been limited by the performance and high cost of power sources and storage devices such as lithium ion batteries. Development of a low cost electrolyte is critical to attaining significant cost reduction over the state-of-the-art technology.

The current lithium ion batteries use electrolytes consisting of organic solvents and a lithium salt. Typical organic solvents used are propylene carbonate (PC), ethylene carbonate (EC), diethylene carbonate (DEC), and dimethyl carbonate (DMC). Typical lithium salts include lithium hexafluorophosphate (LiPF₆), lithium tetrafluoroborate (LiBF₄), and lithium perchlorate (LiClO₄). All commercial Li-ion batteries currently use LiPF₆. In order to meet certain design criteria such as rate capability and energy density, nearly 35% of a battery cell's volume must be filled with electrolyte. The major cost contribution to the lithium ion battery electrolyte is the lithium salt, and the electrolyte is the most expensive component of the battery in view of recent cost cutting advances in electrode material and cell manufacturing technologies.

Lithium salts for lithium ion battery electrolytes are intrinsically difficult to manufacture due to difficulty in synthesis and separation, whereas other alkaline metal salts such as sodium salt are much easier to produce. In addition, sodium and potassium are much more abundant than lithium, also contributing to the lower price of the corresponding electrolyte. As a comparison, the price of battery grade of LiPF₆ is about four times that of sodium hexafluorophosphate (NaPF₆) and the price of LiClO₄ is nearly ten times that of sodium perchlorate (NaClO₄). Thus, if these alkaline metal salts can replace lithium salts as the electrolyte for lithium ion cells, the cost would be substantially lower.

Therefore, this invention provides a way to use much less expensive salts to replace part of the expensive lithium salt without changing the current battery fabrication process or compromising battery performance.

### SUMMARY OF THE INVENTION

Lithium ion batteries generally include a cathode, anode and electrolyte. A mixed lithium sodium (Li/Na) electrolyte is used in accordance with the systems and methods of the invention. The inventive process involves selection of lithium and sodium salts and solvents, preparation of electrolytes and adjustment of the amount of electrolyte used in lithium ion batteries. Battery cells prepared with an electrolyte containing a mixture of Li/Na salt exhibit about the same capacity as those using pure lithium salt electrolyte. More importantly, these cells demonstrate improved cyclability, smaller internal resistance (IR) and better rate capability than those using a pure lithium salt electrolyte. The new electrolyte is also electrochemically stable within a voltage range of 4.8 to 2.5V. Therefore, the mixed Li/Na salt electrolyte is not only a low cost alternative for pure lithium salt electrolyte, it also has the potential to enhance the electrochemical properties of lithium ion batteries because of its enhanced electrochemical properties such as increased conductivity.

The invention accordingly aims to achieve at least one, more or a combination of the following objectives:

To provide suitable salts for electrolytes.

To provide suitable solvents for electrolytes.

To provide a suitable low cost electrolyte for lithium ion batteries.

To provide an electrolyte having better conductivity.

To provide a low cost electrolyte for present lithium ion batteries without changing existing manufacturing procedures.

To provide a low cost electrolyte for super-capacitors and other electrochemical systems without changing existing manufacturing procedures.

To provide low cost electrolytes that enhances the cycle life of lithium ion battery cells.

### BRIEF DESCRIPTION OF THE DRAWINGS

Table 1 is a table of the conductivity of a lithium sodium (Li/Na) mixed salt electrolyte of this invention as compared to the conductivities of several existing electrolyte systems.

FIG. 1 is a schematic drawing of an embodiment of a cell.

FIG. 2 is a graph of the cyclability of the lithium/carbon (Li/C) half-cells with different electrolytes in which charge capacity is plotted as a function of cycle number.

FIG. 3 is a graph of the discharge capacity of lithium/lithium cobalt oxide (Li/LiCoO₂) cells as a function of cycle number with different electrolyte systems.

FIG. 4 is a graph of the discharge capacity of the carbon/lithium cobalt oxide (C/LiCoO₂) cell versus cycle number using different electrolyte systems.

Table 2 shows IR drops of the different cells filled with different electrolytes.

FIG. 5 is a graph of the rate capabilities of the Li/C cells with different electrolyte systems in which the specific capacities at the 3^{rd} cycle were plotted against current densities.

FIG. 6 is a graph of the rate capabilities of the Li/LiCoO₂ cells with different electrolyte systems in which the specific capacities at the 3^{rd} cycle were plotted against current densities.

FIG. 7 is a graph of the rate capabilities of the C/LiCoO₂ full lithium ion cells with different electrolyte systems in which the specific capacities at the 3^{rd} cycle were plotted against current densities.

FIG. 8 is a graph of the charge and discharge capacities of C/LiCoO₂ cell up to 4 cycles where the cell was cycled within the voltage window between 2.5 and 4.8 V using the mixed electrolytes.

### DETAILED DESCRIPTION

Reference will now be made in detail to preferred embodiments of the invention, examples of which are illustrated in the accompanying drawings.

This invention encompasses systems and methods for providing an electrolyte having a multi-salt mixture. The electrolyte can be used in electrochemical systems such as lithium ion batteries and capacitors. Suitable lithium ion batteries for use with this invention includes but is not limited to coin type batteries, cylindrical type batteries, prismatic batteries, liquid batteries and plastic batteries. Lithium ion batteries typically include cathode, anode, separator layers and electrolyte. The electrolyte is added to the battery structure to soak all of layers and serves as a carrier to transport ions from one electrode to another. Lithium salt used in electrolyte is the most expensive material used in the lithium ion battery. This invention replaces the lithium salt used in electrolyte with less expensive alkali metal salts such as sodium and potassium salts.

### EXAMPLE 1

The solubility and conductivity of the alkaline metal ions containing electrolytes were examined at room temperature (˜25° C.). An electrolyte containing a mixture of Li/Na electrolytes was tested in Li/C, Li/LiCoO₂ half-cells and full type C/LiCoO₂ lithium ion cells. It was shown that the amount of the electrolyte and the Li/Na ratio are crucial to the electrochemical performance of these cells in terms of capacity, reversibility and cyclability. Similar solvents, for instance ethylene carbonate and diethyl carbonate in a weight ratio of 2/1 used in existing commercial electrolyte such as LP31 available from EM industries, 7 Skyline Drive, Hawthorne, N.Y. 15032 were used in this invention. The weight ratio of ethylene carbonate (EC) to Diethyl carbonate (DMC) is 2:1 and the total salt concentration is 1M (1 mole/L). After melting EC at 50° C. and mixing with DMC, proper amounts of NaPF₆ and LiPF₆ were added to adjust the total concentration to 1M. All the solutions are clear at room temperature, which implies that the preparation of a higher concentration alkali metal containing electrolyte is possible which is crucial to lithium ion batteries. Conductivities of various electrolytes were further evaluated using NaPF₆/LiPF₆ mixed solution in comparison with those used pure NaPF₆ and LiPF₆ salts and the results are listed in Table 1. The conductivity of the electrolyte was measured using an ORION conductivity meter available from ORION Research Inc., 500 Cummings Center, Beverly, Mass. 01915. The conductivity of 1M NaPF₆ in EC-DMC (in a weight ratio of 2 to 1) is 14.34 mS/cm. The conductivity increases with increasing sodium and potassium concentration and varies from 12 to 14 mS/cm. All of these values are higher than that of 1 M LiPF₆ in EC-DMC in a weight ratio of 2 to 1, which has a conductivity of 10.78 mS/cm.

Table 1 10 shows a chart comparing the conductivities of 0.5M LiPF₆ and 0.75M LiPF₆ electrolytes. The conductivities of 0.5M LiPF₆ and 0.75M LiPF₆ are lower than 10 mS/cm. From an ionic conductivity point of view, the electrolyte that contains the sodium salt demonstrates advantages in comparison with pure lithium electrolyte and implies that low cost metal salts can replace at least part of the LiPF₆ salt used in lithium ion batteries.

### EXAMPLE 2

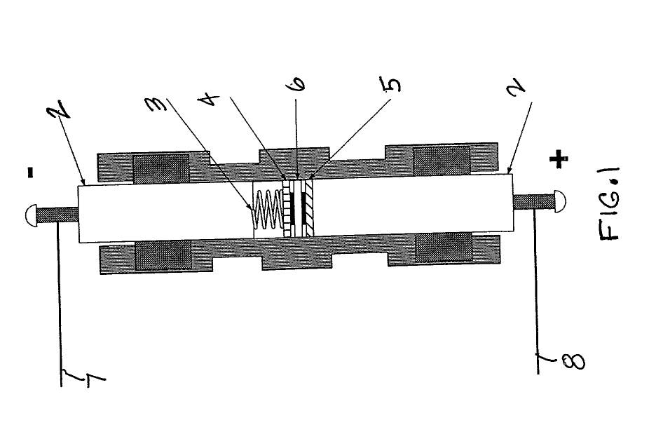

Cells with a structure of Li/electrolyte/carbon were fabricated. A schematic drawing of an embodiment of the cell 1 is shown in FIG. 1. Cell 1 includes plungers 2 at both ends of Cell 1, a spring 3 disposed within the plunger 2, a counter electrode 4 positioned adjacent to the spring 3, a working electrode 5 separated from the counter electrode 4 by separators 6 and leads 7, 8 to connect to the negative and positive terminals of Cell 1. Cell 1 was fabricated with the Swagelok vacuum system fitting technology and is referred to as a Swagelok cell.

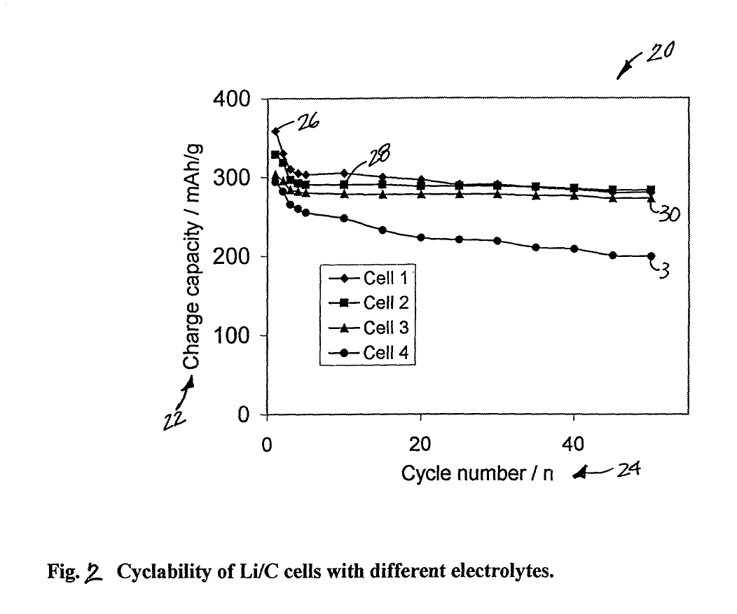

Carbon electrodes with 90% of active material were cast on a single side of a copper (Cu) foil. The actual carbon loading was 12.2 mg/cm². The electrode area was 0.6 cm². Lithium metal was used as counter electrode and Celgard 2400 available from Celgard, Inc., 13800 South lakes Drive, Charlotte, N.C. 28273 was used as separator. Cell fabrication was carried out in a glove box available from Mbraun, 65 Parker Street, Newburyport, Mass. 01950 filled with argon. The samples were tested at a constant current density of 0.5 mA/cm² and cycled between 0 and 1.5 Volts vs. Li/Li⁺ at 25° C. The cycling tests were controlled by a Maccor Battery Testing system available from Maccor Inc., 2805 West 40^{th} Street, Tulsa, Okla. 74107. The cyclability of the Li/C half-cells with different electrolytes are shown in FIG. 2 in which charge capacity is plotted as a function of cycle number. The electrolyte used for Cell 1, 2, 3, and 4 were 1M LiPF₆, 0.7M LiPF₆+0.3M NaPF₆, 0.5M LiPF₆+0.5M LiPF₆, and 0.5M LiPF₆, respectively. The solvent was a mixture of EC-DMC in a 2 to 1 weight ratio. Although the initial capacities of the cells used mixed electrolyte (e.g., Cell 2 and 3) are a few percent less than those used pure Li salt (Cell 1), the cells with mixed electrolyte exhibit better specific capacity and reversibility.

FIG. 2 is a graph 20 of cell charge capacity 22 versus the number of cycles 24 Li/C cells with different electrolytes. The plots of the performance of four cells 26, 28, 30 and 32 are shown. As shown in the FIG. 1, Cell 2 and Cell 3 exhibit excellent cyclability as defined by minimal change in specific capacity with increasing cycle numbers. The charge capacity of these cells at the 50^{th} cycle is almost the same as that of Cell 1.

Furthermore, Li/Na ratio in mixed electrolytes also affects the electrochemical performance of Li/C cell. Higher Li/Na ratios lead to better electrochemical performance in terms of capacity and cyclability. Cell 1 26 made with the electrolyte with Li/Na ratio of 7/3 shows almost the same initial capacity as those using pure 1M LiPF₆ electrolyte and also demonstrates improved cyclability. Cell 4 which used pure 0.5 M LiPF₆ exhibits disadvantages both in capacity and cyclability. These results clearly indicate that addition of sodium salt in the electrolyte is beneficial to cell performance.

### EXAMPLE 3

Swagelok test cells with structures of Li/electrolyte/LiCoO₂ were fabricated. LiCoO₂ was coated on a stainless steel foil with an active loading of 26.2 mg/cm². The active material loading was 91%. The cell was cycled at a constant current of 0.5 mA/cm² and the voltage window was from 4.2 to 3.0V vs. Li⁺/Li. The same amount of electrolytes was used as those used in Li/C cells, that is, 30 μL (1 μL=10⁻⁶ liter) of electrolyte was used when the lithium/sodium ratio is 1 to 1.35 μL electrolyte was used when the lithium/sodium ratio is 7/3.

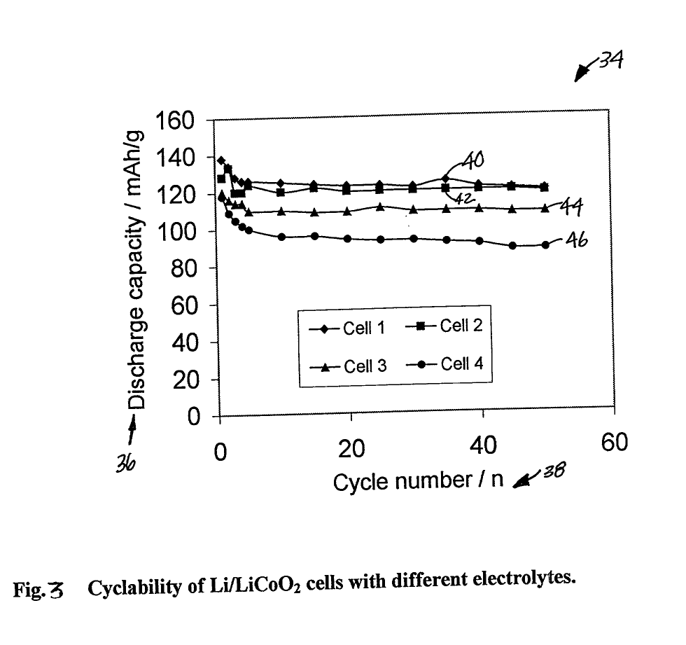

FIG. 3 is a graph 34 of cell discharge capacity 36 versus the number of cycles 38 Li/LiCoO₂ cells with different electrolytes. The plots of the performance of four cells 40, 42, 44, and 46 are shown. As shown, the discharge capacity of LiCoO₂ as a function of cycle number for several electrolyte systems is displayed. The electrolyte used for Cell 1, 2, 3, and 4 were 1M LiPF₆, 0.7M LiPF₆+0.3M NaPF₆, 0.5M LiPF₆+0.5M LiPF₆, and 0.5M LiPF₆, respectively. Cell 2 exhibits similar electrochemical performance as Cell 1 in terms of capacity and cyclability. Although Cell 3 exhibited capacity a few percent smaller than those of Cell 2 and Cell 1, it demonstrates excellent cyclability and retained about 92% of initial discharge capacity up to 50 cycles. Compared with Cell 3, Cell 4 (which used pure 0.5 M LiPF₆ electrolyte) showed disadvantages both in capacity and cyclability, suggesting that the presence of sodium in the electrolyte has very positive effects on cell performances. These results indicated that the mixed salt electrolyte is superior to current commercial single Li salt electrolytes for lithium ion batteries with LiCoO₂ as the cathode material.

### EXAMPLE 4

A well-matched carbon anode and LiCoO₂ cathode were used to fabricate C/LiCoO₂ cells. The cells were filled with electrolytes with different Li to Na ratios. The fabricated full lithium ion cells were cycled at a constant current of 0.5 mA/cm² and the voltage range during cycling was from 4.2 to 2.5V.

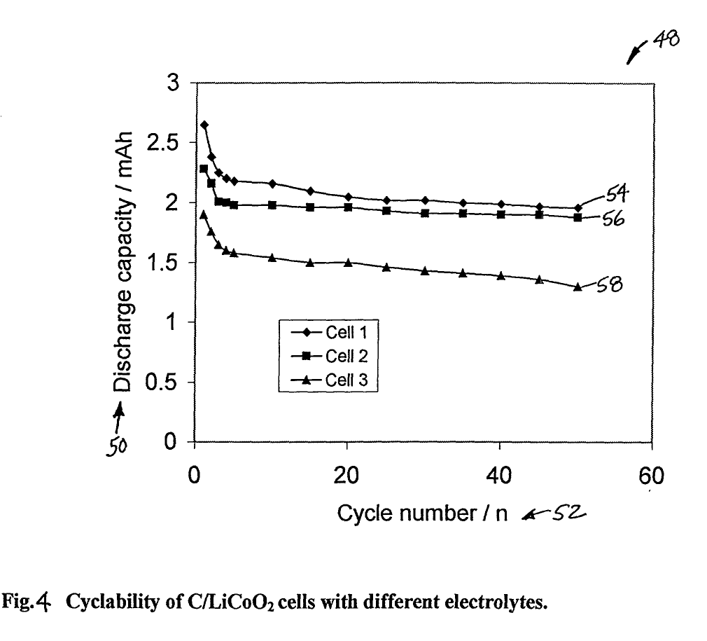

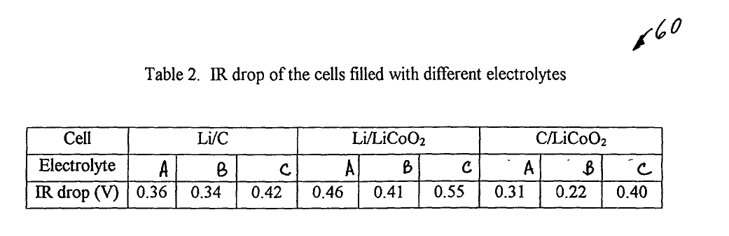

FIG. 4 is a graph 48 of cell discharge capacity 50 versus the number of cycles 52 of C/LiCoO₂ cells with different electrolytes. The plots of the performance of three cells 54, 56, and 58 are shown. The electrolyte used for Cells 1, 2, and 3 were 1M LiPF₆, 0.5M LiPF₆+0.5M LiPF₆, and 0.5M LiPF₆, respectively. The amount of electrolyte used is 35 μL. Cell 2 showed comparable capacity and cyclability with Cell 1 and far more than Cell 3 which has no sodium salt additive in the electrolyte. Cell 2 showed very good cyclability, when it was cycled to 50 cycles, and has nearly the same capacity as Cell 1. The results indicate that a much less expensive sodium salt can be used to replace part of the expensive lithium salt without adversely affecting battery's performance in the terms of capacity and cyclability.

### EXAMPLE 5

The voltage drop due to the internal resistance (or IR drop) of Li/C, Li/LiCoO₂ and C/LiCoO₂ cells was tested and the results are listed in Table 2. Three different electrolytes with different Li/Na ratios were used in this example. The cells were cycled at a constant current density of 1 mA/cm². The cutoff voltages of the cells varied and were the same as those in cyclability tests stated above. After reaching the charge or discharge cutoff voltage point, the cell was then rested for about one minute to reach quasi-equilibrium and then continued to the next discharge or charge procedure at the same current density. The IR drops were measured at the third cycle at both charging and discharging onset points, as the cell performances were stabilized after 2 cycles. The results show that a mixed 0.5M LiPF₆+0.5M NaPF₆ in EC-DMC electrolyte (electrolyte B) gave lower IR drops in all three types of cells. The average IR drop for the cells using electrolyte B (with mixed Li/Na salt) is consistently less than those using electrolyte A and C that used no sodium salt. The smaller IR drops for mixed electrolyte cells is another advantage of the inventive electrolyte.

### EXAMPLE 6

Rate capability is very important for electric vehicle applications, as it requires large operating current. The rate capabilities of cells having the mixed electrolyte were compared to pure lithium salt electrolytes using the same Swagelok cells. The cells were cycled at a constant current density of 0.5 mA/cm² to 3 mA/cm², which corresponds to a charge/discharge rate of C/8 to C, i.e. the rate to fully charge/discharge the cell in 8 hours to 1 hour.

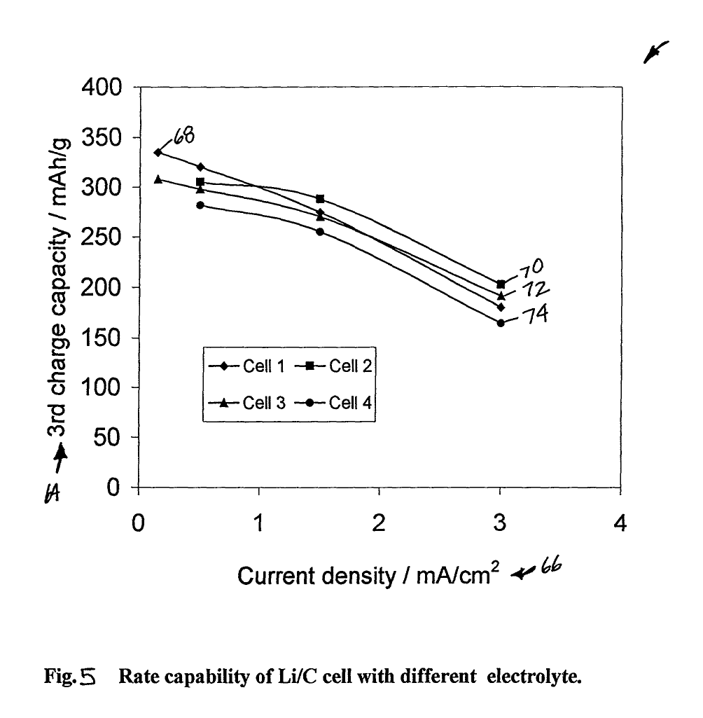

FIG. 5 is a graph 62 of the third charge capacity 64 versus the number of cycles 66 for Li/C cell with different electrolytes. The plots of the performance of four cells 68, 70, 72 and 74 are shown. As shown in FIG. 5, the rate capabilities of the Li/C cells with different electrolyte systems in which the 3^{rd} cycle specific capacity are plotted against the current density. 30 μL of electrolyte was used when the molar ratio of lithium/sodium is 1 to 1.35 μL of electrolyte was used when the lithium/sodium ratio is 7 to 3. The cutoff voltage is 0-1.5V vs. Li/Li⁺. Cell 1 used pure 1M LiPF₆ electrolyte, Cell 2 used 0.7M LiPF₆+0.3M NaPF₆ electrolyte. Cell 3 used 0.5M LiPF₆+0.5M LiPF₆ electrolyte, and Cell 4 used pure 0.5M LiPF₆ electrolyte. As shown in FIG. 5, both Cells 2 and 3, which used mixed electrolytes, exhibit better rate capability than Cell 1 and Cell 4, which used pure Li electrolyte.

### EXAMPLE 7

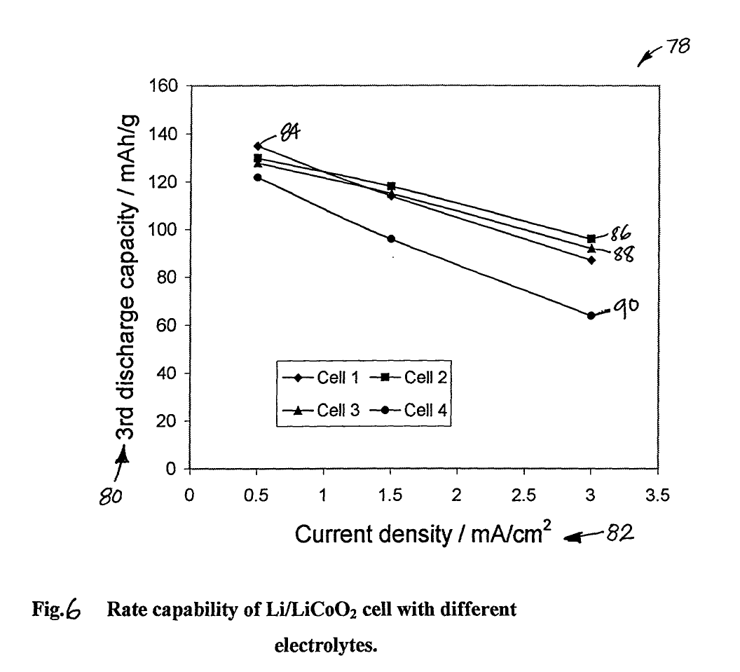

FIG. 6 is a graph 78 of the third discharge capacity 80 versus the number of cycles 82 for a Li/LiCoO₂ cell with different electrolytes. The plots of the performance of four cells 84, 86, 88 and 90 are shown. As shown in FIG. 6, the rate capabilities of the Li/LiCoO₂ cells with different electrolyte systems in which the 3^{rd} specific capacity is plotted against the current density. The amounts of electrolytes used were the same as Li/C cells. 30 μL of electrolyte was used when the molar ratio of lithium/sodium is 1 to 1.35 μL of electrolyte was used when the lithium/sodium molar ratio is 7 to 3. The cutoff voltage was 3-4.2V vs. Li/Li⁺. The electrolyte used for Cell 1, 2, 3, and 4 were 1M LiPF₆, 0.7M LiPF₆+0.3M NaPF₆, 0.5M LiPF₆+0.5M LiPF₆, and 0.5M LiPF₆, respectively. As can be seen from this figure, both Cells 2 and 3 with mixed electrolytes show better rate capability than Cells 1 and 4 using pure lithium electrolyte.

### EXAMPLE 8

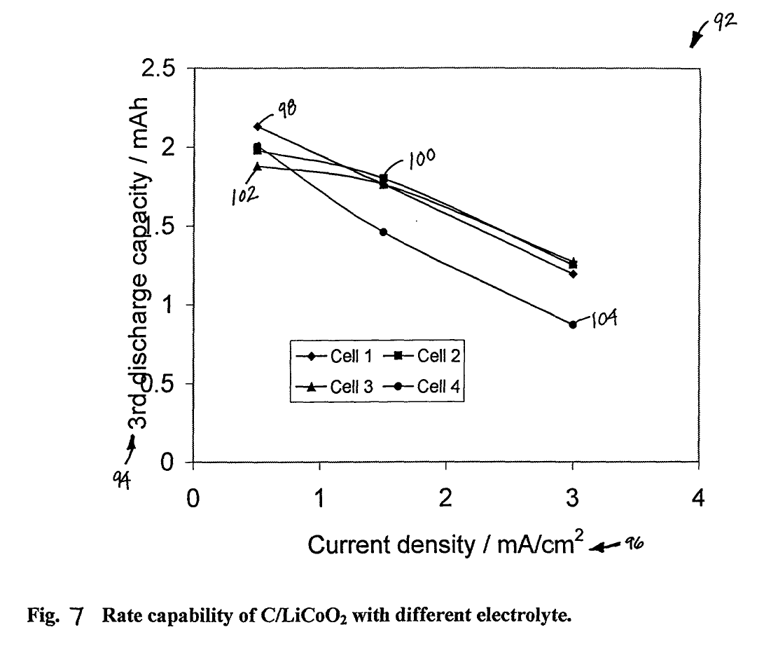

FIG. 7 is a graph 92 of the third discharge capacity 94 versus the number of cycles 96 for a C/LiCoO₂ cell with different electrolytes. The plots of the performance of four cells 98, 100, 102 and 104 are shown. As shown in FIG. 7, the rate capabilities of the Ci/LiCoO₂ cells when different electrolyte systems were used. The 3 cycle specific capacities were plotted against the current density. 35 μL of electrolytes was used when the molar ratio of lithium/sodium is 1 to 1. 40 μL of electrolytes was used when the molar ratio of lithium/sodium was 7 to 3. The electrolyte used for Cells 1, 2, 3, and 4 were 1M LiPF₆ electrolyte, 0.7M LiPF₆+0.3M NaPF₆ electrolyte, 0.5M LiPF₆+0.5M LiPF₆ electrolyte, and pure 0.5M LiPF₆, respectively. The voltage range for cycling is 2.5-4.2V. As shown in FIG. 7, both Cells 2 and 3 that used mixed electrolytes demonstrate better rate capability than Cells 1 and 4 that used pure lithium salt in the electrolyte. When the cells were cycled at a current density of 0.5 mA/cm², Cell 1 gave larger capacity than Cell 2 and Cell 3. When the current densities reached 1.5 mA/cm², Cells 1, 2, and 3 have almost the same capacity. These results indicate that much less expensive sodium salts can replace at least part of the expensive lithium salt and improve rate capability.

C/LiCoO₂ was fabricated using mixed 0.5M LiPF₆+0.5M NaPF₆ electrolyte to examine the electrochemical stability of the mixed electrolyte. The amount of electrolyte used was 35 μL. The cell was intentionally charged to 4.8V and then discharged to 2.5V at a constant current density of 1 mA/cm².

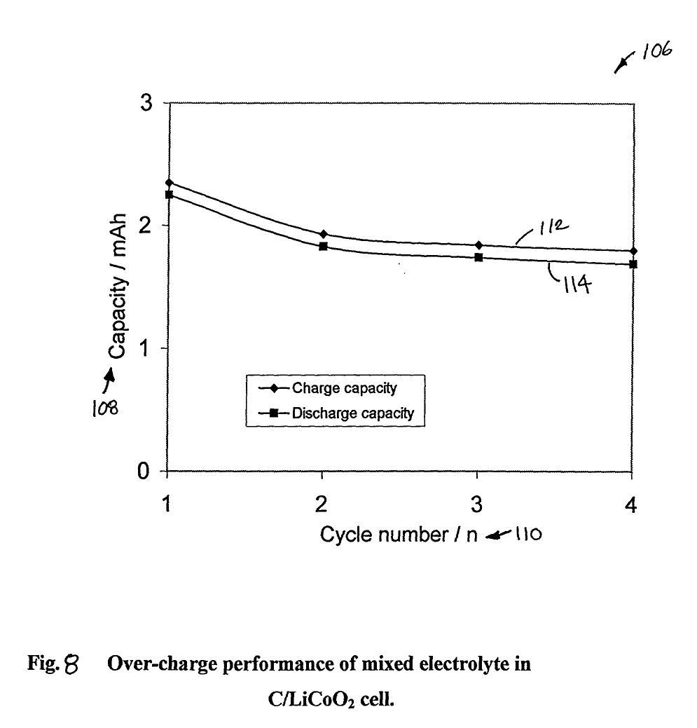

FIG. 8 is a graph 106 of the capacity 108 versus the number of cycles 110 of the overcharge performance of a mixed electrolyte in a C/LiCoO₂ cell. Plots of the charge capacity 112 and discharge capacity 114 are shown. FIG. 8 shows the capacity of the cell up to 4 cycles. The reversibility is very good, which means that the mixed salt electrolyte is stable at least at the cell operation voltage window and can be applied to a high voltage cathode such as LiMn₂O₄ cathode.

An advantage of the mixed salt electrolyte of this invention is that it can be used in a variety of applications involving electrochemical systems including lithium batteries, lithium ion batteries, super capacitors, electrochromic devices, and sensors. This invention is particularly useful for applications where a high power rate is required.

Another advantage of the mixed salt electrolyte of this invention is that it can be used in numerous types of lithium ion batteries including types of cells, coin cells, cylinder cells and plastic cells.

Yet another advantage of this invention is that an electrolyte having a mixture of Li/Na has improved performance over electrolytes prepared with 1 molar LiPF₆ in EC-DMC electrolyte.

The foregoing is provided for purposes of illustrating, explaining and describing several embodiments of this invention. Modifications and adaptations to these embodiments will be apparent to those of ordinary skill in the art and may be made without departing from the scope or spirit of the invention and the following claims. Also, the embodiments described in this document in no way limit the scope of the claims stated below as persons skilled in this art recognize that this invention can be easily modified for use to provide additional functionalities and for new applications.

We claim:

1. A method of forming a lithium/sodium (Li/Na) mixed salt electrolyte for electrochemical systems, comprising:
a. depositing lithium salts;
b. adding sodium salts; and
c. adding non-aqueous solvents.

2. The method of claim 1, further comprising forming the Li/Na mixed salt electrolyte having a Li/Na ratio in a range of 0.1 to 10.

3. The method of claim 1, wherein the Li/Na mixed salt electrolyte is prepared with lithium salts selected from group consisting of:
a. LiClO₄;
b. LiPF₆;
c. LiBF₄;
d. LiCF₃SO₃; and
e. LiAsF₆

4. The method of claim 1, wherein the Li/Na mixed salt electrolyte is prepared with sodium salts selected from the group consisting of:
a. NaClO₄;
b. NaPF₆;
c. NaBF₄;
d. NaCF₃SO₃; and
e. NaAsF₆.

5. The method of claim 1, wherein the Li/Na mixed salt electrolyte is prepared with nonaqueous solvents selected from the group consisting of:
a. Acetonitrite (C₂H₃N);
b. γ-Butyrolactone (C₄H₆O₂);
c. Diethyl carbonate (C₅H₁₀O₃);
d. 1,2-Dimethoxyethane (C₄H₁₀O₂);
e. Dimethyl carbonate (C₃H₆O₃);
f. 1,3-Dioxolane (C₃H₆O₂);
g. ethylene carbonate (C₃H₄O₃);
h. Ethyl methyl Carbonate (C₄H₈O₃);
i. 1-methyl-2-pyrrolidinone (C₅H₉NO);
j. Propylene Carbonate (C₄H₆O₃); and
k. Tetrahydrofuran (C₄H₈O).

6. The method of claim 1, further comprising:
a. positioning a cathode material on a first side of the Li/Na mixed salt electrolyte; and
b. positioning an anode material on a second side of the Li/Na mixed salt electrolyte.

7. A battery, comprising:
a. a cathode material-,
b. a Li/Na mixed salt electrolyte positioned adjacent to the cathode; and
c. an anode material positioned adjacent to the Li/Na mixed salt electrolyte.

8. The battery of claim 7, wherein the cathode material is selected from the group consisting of:
a. LiCoO₂,
b. V₂O₅;
c. LiMn₂O₄;
d. MnO₂;
e. LiNiO₂; and
f. TiS₂.

9. The battery of claim 7, wherein the cathode material further comprises a quaternary spinel LiMₓMn₂₋ₓO₄.

10. The battery of claim 9, wherein the quaternary spinel LiMₓMn₂₋ₓO₄ further comprises LiMn₂O₄ doped by various 3d transition metals selected from the group consisting of Ti, Ge, Fe, Zn, Co, Cr and Ni doped LiMₓCo₁₋ₓO₂, wherein M is selected from the group consisting of Ni, Ti, Ge, Fe, Zn, and Cr, x=0 to 1, and doped vanadium oxide such as V₂₋ₓMₓO₅ and V₆₋ₓMₓO₁₃ and where M is selected from the group consisting of Co, Cr, Ni, V, W, Mo and where x is from 0 to 1.

11. The battery of claim 7, wherein the anode material is selected from the group consisting of carbon, tin oxides, and tin nitrides.

12. The battery of claim 7, further comprises a lithium ion battery.

13. The battery of claim 7, further comprises a lithium battery.

14. The battery of claim 7, wherein the Li/Na mixed salt electrolyte further comprises lithium salts, sodium salts and non-aqueous solvents.

15. The battery of claim 14, wherein the lithium salts are selected from the group consisting of
a. LiClO₄;
b. LiPF₆;
c. LiBF₄;
d. LiCF₃SO₃; and
f. LiAsF₆.

16. The battery of claim 14, wherein the sodium salts are selected from the group consisting of:
a. NaClO₄;
b. NaPF₆;
c. NaBF₄;
d. NaCF₃SO₃; and
g. NaAsF₆.

17. The battery of claim 14, wherein the non-aqueous solvents are selected from the group consisting of:
a. Acetonitrite (C₂H₃N);
b. r-Butyrolactone (C₄H₆O₂);
c. Diethyl carbonate (C₅H₁₀O₃);
d. 1,2- Dimethoxyethane (C₄H₁₀O₂);
e. Dimethyl carbonate (C₃H₆O₃);
f. 1,3-Dioxolane (C₃H₆O₂);
g. ethylene carbonate (C₃H₄O₃);
h. Ethyl methyl Carbonate (C₄H₈O₃);
i. 1-methyl-2-pyrrolidinone (C₅H₉NO);
Propylene Carbonate (C₄H₆O₃); and
k. Tetrahydrofuran (C₄H₈O).

18. The battery of claim 12, wherein the lithium ion battery is selected from the group consisting of:
a. a coin type battery;
b. a cylindrical type battery;
c. prismatic batteries;
d. liquid batteries; and
e. plastic batteries.

19. The battery of claim 7, wherein the battery performs as a capacitor.

20. The battery of claim 7, wherein a mixture of lithium and sodium of the Li/Na mixed salt electrolyte comprises a ratio of 0.1 to 10.
